(19) United States
(12) Patent Application Publication
(10) Pub. No.: US 2003/0046765 A1
(43) Pub. Date: Mar. 13, 2003

(54) Polyurehane foam and down filling

(76) Inventor: Teresa Brown, Cedar Park, TX (US)

Correspondence Address: Teresa Brown, 2613 Goldfinch Dr., Cedar Park, TX, 78613, US

(21) Appl. No.: 09/949,521

(22) Filed: Sep. 7, 2001

(51) Int. Cl. B32B 1/06; A47G 9/00

(52) U.S. Cl. 5/636; 428/71; 428/74; 5/950

(57) ABSTRACT

A filling material comprised of a flexible and highly resilient polyurethane foam, combined with a soft and plush down fill. The filling material is inserted or blown into a casing to form a pillow or other cushioned articles. The filling elements offer adequate support and softness with a “cradling effect” of a person's head. The filling elements retain its shape and bounce back to its original state.

### BACKGROUND OF THE INVENTION

This invention relates to a filling material that can be used for pillows, mattress pads, cushions, comforters, sleeping bags, and the like.

A filling material, especially for pillows, should meet several criteria. For example, it should be resilient and flexible so that it retains its shape. It must be soft to initial contact but at the same time provide adequate support.

Natural materials such as cotton wadding, feathers and down have been used in the past for such filling materials. Among these materials, down (the light fluffy undercoating of waterfowl) is considered optimal where properties of compression recovery, softness and moisture transmission are concerned. However, down is deficient in quality of support.

Cotton does not provide the comfort or luxury of down. Cotton tends to clump together and does not sufficiently recover to its uncompressed state.

Feathers have been used in the making of pillows and other upholstered articles. Feathers, the principle covering of birds are of flat, two-dimensional construction, and have a hard tubular quill shaft from one end to the other. However, feathers are deficient where softness is concerned and lacks loftiness and filling power.

Down consists of filaments growing from central quill points. A down cluster has a quill point but no quill shaft, therefore it is far more resilient than a feather, it is three-dimensional rather than two and therefore has more loft and filling power.

Whereas down being a desirable material, one approach was to utilize a synthetic polyolefin (U.S. Pat. No. 5,405,694, trademark name, Natures Twin) to simulate natural down. The polyolefin filled pillow has serious disadvantages, as it does not possess the permanent resilience and softness of down.

Natural down pillows are desirable because of their softness, loftiness and durability. However, there is a significant problem where down pillows are concerned due to the deficiency of the quality of support. When down is compressed during use of the pillow, it allows the user's head to sink to the bottom of the pillow due to its lack of support and may contribute to a stiff or sore neck.

Polyurethane foam is a light, durable, flexible, and highly resilient material. The foam retains its shape and has a “bounce back effect”. Thus providing a high quality of support. Polyurethane foam supplies the needed support that down lacks, it combines with down for an excellent filling material to be used in the making of pillows and other cushioned articles.

### BRIEF SUMMARY OF THE INVENTION

The present invention provides a resilient and plush filling material and more particularly relates to a bed pillow which combines all the essential requirements for optimum application, including good support properties, superior comfort and a “cradling effect” of a person's head. All of which are very important for sound inducing sleep.

### A DETAILED DESCRIPTION OF THE INVENTION

Down goes through a number of steps before it can be utilized commercially. The down is first washed through special German washers with gentle soaps to remove any impurities. The batch is then put through warm water and rinsed many times. After the final rinse is given, the batch is steam dried to give the down resilience, thereby giving the cushion its body and bounce.

Down suitable to be prepared for use in the invention is available commercially under various trade names such as Feathers Industries (Canada) Limited of Toronto, Canada.

Polyurethane foam, suitable to be prepared for use in the invention is available commercially under various trade names such as Foam Products of San Antonio, San Antonio, Tex.

Polyurethane foam and down clusters are mixed together to produce a synergy of foam/down material for filling pillow cores, mattress pads, cushions, comforters, sleeping bags, upholstered items and the like.

The filling material is packed or blown into fabric enclosures to form superior pillows and other cushioning articles.

I claim:

1. A filling element to be inserted into a casing to form a pillow, mattress pad, cushion, comforter, sleeping bag, upholstered article, or the like, comprising:
polyurethane foam combined with down and where the filling is inserted into a casing, causing the filling elements to provide adequate support and softness.
